(19) United States
(12) Patent Application Publication
(10) Pub. No.: US 2019/0287383 A1
(43) Pub. Date: Sep. 19, 2019

(54) Multi-Functional Personal Security System

(71) Applicant: Orrick R. Quick, High Point, NC (US)

(72) Inventor: Orrick R. Quick, High Point, NC (US)

(21) Appl. No.: 16/357,900

(22) Filed: Mar. 19, 2019

Related U.S. Application Data
(60) Provisional application No. 62/644,871, filed on Mar. 19, 2018.

(51) Int. Cl. G08B 25/01; G08B 25/00; G08B 25/10; G08B 25/12

(52) U.S. Cl. CPC G08B 25/016; G08B 25/005; G08B 25/12; G08B 25/008; G08B 25/10; G08B 25/006

(57) ABSTRACT

A personal security system includes a handheld and portable alert device suitable for being carried in a woman's purse or even tethered about her neck. The alert device includes multiple input buttons—each being associated with different levels of insecurity, danger, or need for immediate assistance. The alert device may also be equipped with audio and/or visual alarms, bright lights, and a transmitter operable to contact police or security authorities immediately. In addition, the alert device may include a global position satellite (GPS) module or transponder operable to give exact geographic coordinates to police or other predetermined contacts as an aid in locating the alert device and user quickly.

### REFERENCE TO RELATED APPLICATIONS

This application claims the benefit of provisional patent application Ser. No. 62/644,871 filed Mar. 19, 2018 titled Multi-Functional Personal Security System, which is incorporated completely herein by reference.

### BACKGROUND OF THE INVENTION

This invention relates generally to security devices and, more particularly, to a personal security system in which different degrees of insecurity may be selected by a user and signals transmitted accordingly to appropriate personnel respectively.

There are many different levels of insecurity, anxiety, or fear of imminent harm that one may experience and, correspondingly, there are different solutions or avenues of escape that are appropriate for the experienced level of insecurity. For instance, a young lady may be on a date with a young man and at some point feel uncomfortable with the direction of conversation or physical advances. Rather than seeking to escape the situation or contacting embarrassing law enforcement to what may be nothing more than an awkward situation, the lady may desire to send a clandestine alert to a parent or friend to come interrupt the date, such as with an excuse for why it needs to end early. But in other situations, one's safety may be much more threatened. For instance, the date may have become violent or threats have been made to the point where the young lady feels physical harm may require fast intervention. In this case, she may desire to send a heightened alert to authorities. And if violence is actually happening, sounding a panic alarm drawing immediate attention is appropriate and needful.

Therefore, it would be desirable to have a multi-functional personal security system having a portable signal transmission device capable of transmitting different frequency signals based on respective inputs are pressed by a user corresponding to respective levels of insecurity or imminent harm.

### SUMMARY OF THE INVENTION

The personal security system according to a preferred embodiment of the present invention includes a handheld and portable alert device suitable for being carried in a woman's purse or even tethered about her neck. The alert device includes multiple input buttons—each being associated with different levels of insecurity, danger, or need for immediate assistance. The alert device may also be equipped with audio and/or visual alarms, bright lights, and a transmitter operable to contact police or security authorities immediately. In addition, the alert device may include a global position satellite (GPS) module or transponder operable to give exact geographic coordinates to police or other predetermined contacts as an aid in locating the alert device and user quickly.

Therefore, a general object of this invention is to provide a multi-functional personal security system having a hand-held alert device having a plurality of user inputs for actuating transmission of signals indicative of respective levels of insecurity, danger, or harm.

Another object of this invention is to provide a multi-functional personal security system, as aforesaid, that includes a panic alarm actuator that causes an immediate audio and video alert and electronically or telephonically notifies authorities.

Still another object of this invention is to provide a multi-functional personal security system, as aforesaid, that includes a global position satellite (GPS) tracking device such the location of the alert device may be tracked in real time when activated.

Yet another object of this invention is to provide a multi-functional personal security system, as aforesaid, that includes an alert device dimensioned to fit inside a woman's purse or be worn in the form of a necklace.

A further object of this invention is to provide a multi-functional personal security system operable to transmit an alert meaning “I need a diversion or interruption” to “I am being attacked and need police NOW.”

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of an alert device according to a preferred embodiment of the present invention;

FIG. 2a is a front view of the alert device as in FIG. 1;

FIG. 2b is a top view of the alert device as in FIG. 2a;

FIG. 2c is a bottom view of the alert device as in FIG. 2a;

FIG. 2d is a right side view of the alert device as in FIG. 2a;

FIG. 2e is a left side view of the alert device as in FIG. 2a;

FIG. 3 is a flowchart illustrating the logic performed by the processor in conjunction with the input buttons; and

FIG. 4 is a block diagram illustrating the electronic components of the present invention.

### DESCRIPTION OF THE PREFERRED EMBODIMENT

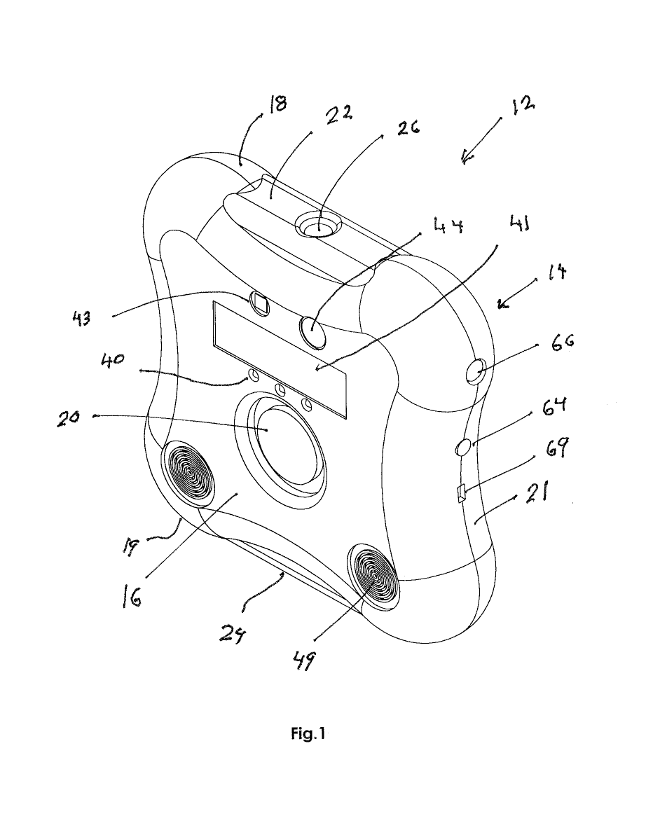

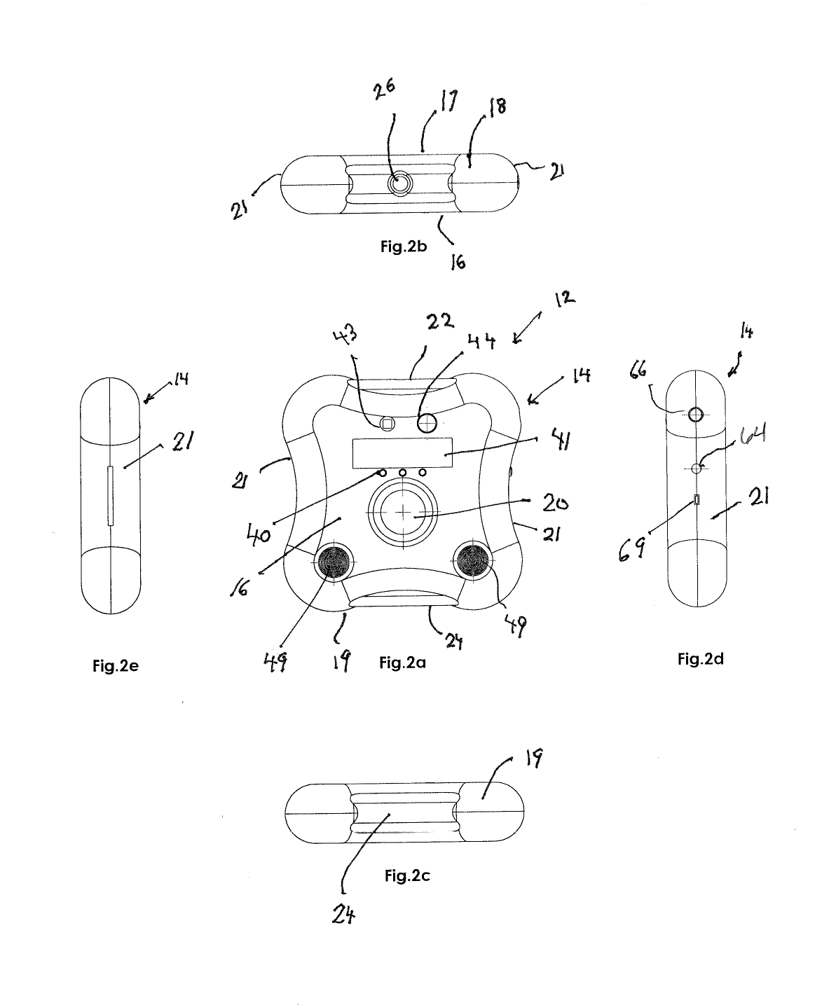

A multi-functional personal security system according to a preferred embodiment of the present invention will be described with reference to FIGS. 1 to 4 of the accompanying drawings. The personal security system 10 includes an alert device 12 having a hand-held housing 14 that includes a transmitter 36 for communicating with an emergency response entity or predetermined contacts, a memory device having owner and contact information, and a GPS 46 for determining position data. The alert device 12 may also include audio and visual alarms 48, a bright lighting device 26, a camera 44, and even defensive equipment such as mace. The alert device 12 may further include a processor 30 in data communication with the user input buttons 32, transmitter 36, a non-volatile memory 38 configured to store data and programming, and the GPS 46. It is understood that the term “input buttons” 32 may refer to the total collection of buttons that may be selected by a user, unless specifically referred to as being a specific button below. The processor 30 may execute programming that actuates the transmitter 36 to automatically provide the owner information, global position data via a GPS activation button that causes the GPS 46 to begin sending tracking data, and a threat-level input selected using the user input device. The key to operation of the alert device is the multiple input means which are illustrated as input buttons although a dial for selecting a threat level along with a single input button is also contemplated. These components and features will be described below in more detail. Further, the alert device 12 may include a digital display 41 operable to display user input selections or other data.

The multi-functional personal security system includes a housing 14 that is portable and dimensioned to fit comfortably in a women's purse or even worn as a necklace. In an embodiment shown in the accompanying illustrations, the housing may have a front wall 16, a rear wall 17 opposite the front wall 16, a top wall 18 and a bottom wall opposite the top wall 18, and side walls 21 extending between the top and bottom walls, respectively, and as shown in the figures. It is understood that the plurality of walls, together, define an interior area of the housing 14 suitable to enclose the several electronic components that will be described below. In other words, the housing 14 essentially defines an electronics box in which electronic components are situated. Various input buttons 32 may be positioned on respective walls of the housing 14 of the alert device 12 and there may be indicia indicating with what level of security intervention is associated with each button.

With further detail with reference to the input buttons, a plurality of input buttons 32 may be positioned on the front wall 16, including an alert level indicator 20 preferably positioned on the front wall 16 and electrically connected to the processor 30. The alert level indicator 20 may be pressed (or otherwise actuated) by a user to indicate various levels of safety, respectively, as will be further described later. A plurality of light emitting diodes (LEDs) 40 may also be positioned on the front wall 16 of the housing 14, each LED being electrically connected to the processor 30 and, therefore, operably connected to the alert level indicator 20. The LEDs 40 are configured to illuminate in coordination with how many times the alert level indicator 20 has been pressed. Similarly, the alert level may be indicated on the display 41 as well. In other words, if the alert level indicator 20 has been pressed one time, then one LED is illuminated. If the alert level indicator 20 has been pressed twice, two LEDs are illuminated, and so on. The housing 14 may also include a top wall 18 and a bottom wall 19 on which a record button 22 and panic button 24 may be positioned as will be described later.

A battery 42 may be situated in the interior area of the housing 14 and electrically to at least the processor 30 and is accessible via a rear wall 17 of the housing 14. A battery light 64 may be electrically connected to the battery 42 and positioned on a wall of the housing 14 to indicate when power is activated. Similarly, an on/off button 66 may be positioned on a wall and electrically connected to at least the processor 30 the enables a user to power the alert device 12 on or off. The battery light 64 may be electrically connected to the on/off button to indicate when the alert device 12 is activated. The side wall 21 may define a port 69 in communication with the battery 42 and operable for being electrically connected to an external power source whereby to charge the battery 42.

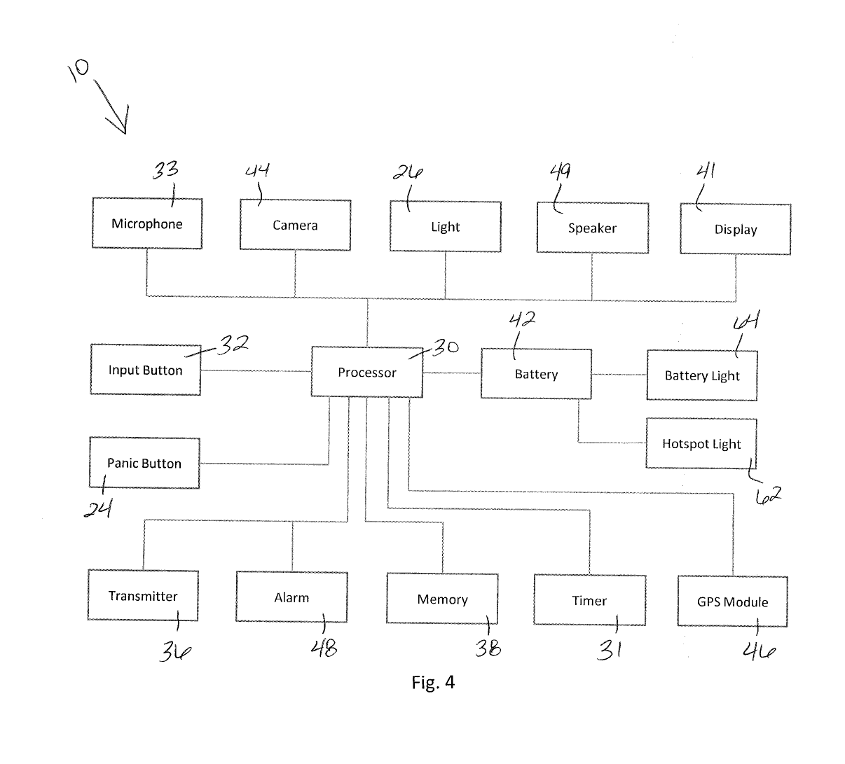

The user alert device 12 includes a transmitter 36 operable and configured to transmit signals indicative of a plurality of messages indicative of levels of a user's feelings of security, other status conditions, and requests for help, respectively. The transmitter 36 may be a signal transmitter, a communications module capable of making cellular signal transmissions, Bluetooth components, Wi-Fi connections, or the like. A selected message may be transmitted as a signal appropriately coded to include an associated message. In an embodiment, a hot spot light 62 (FIG. 4) may be mounted to the housing 14 and operable to illuminate when an internet hot spot is accessible for Wi-Fi communications.

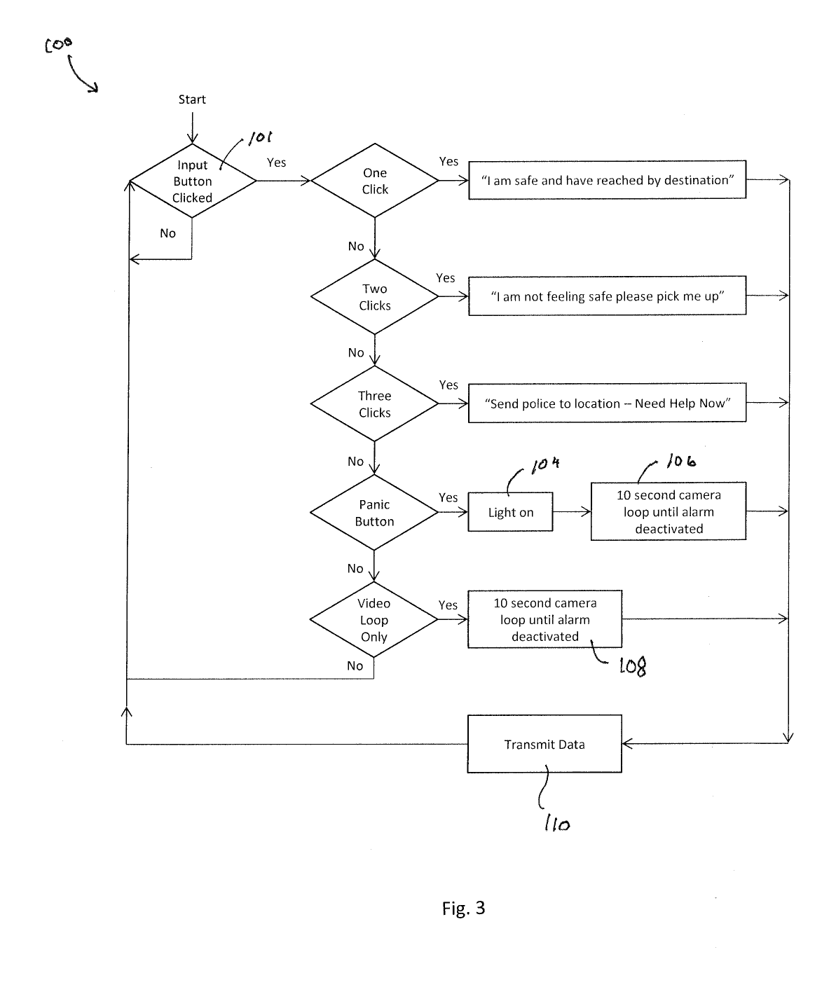

It is understood that a plurality of predetermined messages may be stored in memory 38 and associated with a predetermined number of selections of the alert level indicator 20. Programming instructions associated with the present invention may be provided in the form of a software application stored in the memory 38 for execution by the processor 30 (referred to herein as the software application or software app). A process 100 executed by the software application executed by the processor 30 is illustrated in FIG. 3 and believed to be self-explanatory in view of the following description. In a manner similar to that discussed above, a user pressing the alert level indicator 20 (step 101) initiates the process 100, an actuation of the alert level indicator 20 one time results in the software application (via the processor) actuating the transmitter 36 to transmit a signal embodying a first message indicative of a virtual statement by the user, such as “I am safe and have arrived at my location.” Similarly, a user pressing the alert level indicator 20 two times results in the software application (via the processor) actuating the transmitter 36 to transmit a signal embodying a second message indicative of a virtual statement by the user, such as “I am not safe—please pick me up.” Further, a user pressing the alert level indicator 20 three times results in the software application (via the processor) actuating the transmitter 36 to transmit a signal embodying a third message indicative of a virtual statement by the user, such as “Send police to this location.” In some embodiments, there may be fewer or greater numbers of messages corresponding to more numbers of selections of the alert level indicator 20.

In a related aspect, a predetermined contact list may be stored in memory 38 and associated with respective messages. In other words, a predetermined list of family contacts, security contacts, or the like may be associated with the various levels of safety so that respective messages may be transmitted to predetermined contacts accordingly. For instance, the first message expressing safe arrival at an expected destination may be transmitted to a user's parents (referred to as a “first set of contact data”). Similarly, a message asking to be picked up early may be transmitted to a user's parents, relatives, and selected friends (referred to as a “second set of contact data”). Finally, a message asking for police to be dispatched immediately may be transmitted to a 9-1-1 operator or to a private security company (referred to as a “third set of contact data”).

A camera 44 capable of taking about 10 seconds of video (i.e. a video camera) or at least a progression of still photographs may be mounted substantially inside the interior area of the housing 14 and have a lens (see also reference numeral 44) with a view through a wall of the housing so as to be directed to the outside of the housing 14. The camera 44 may include a flash 43 in the normal understanding regarding photography. The camera 44 may be energized by the processor 30, such as by actuation of an input button as described below, to repeatedly generate video data and then actuate the transmitter 36 to transmit the video data to a predetermined entity or data location, as indicated at step 110 of the process 100 of FIG. 3. It is understood that a timer 31 may be coupled to the processor 30 and camera 44 and operable to count off the 10 seconds for the camera 44 to record a packet of video data for transmission as described above and below.

More particularly, one of the plurality of input buttons 32 may include a record button 22 and another of the plurality of input buttons 32 may include a panic button 24. In an embodiment, the record button 22 may be situated on the top wall 18 of the housing 14 and is electrically connected to the processor 30 and the panic button 24 may be positioned on the bottom wall 19 and electrically connected to the processor 30. Of course, other positioning of the input buttons 32 are contemplated. The processor 30, under the control of the software application, (i.e. programming) is operable to initiate specific actions depending on if the record button 22 is pressed by itself or in combination with the panic button 24. For instance, the software application is operable to cause the processor 30 to actuate the camera 44 to begin generating video data in 10 second packets when the record button 22 is pressed by itself (such as at step 108) and then to cause the processor 30 to actuate the transmitter 36 to transmit recorded video for receipt by a security entity, parents, or according to the predetermined contact information as shown at step 110 of FIG. 3.

In addition, actuation of the panic button 24, which is electrically connected to the processor 30, causes immediate transmission of communication signals, such as via a communications module, to predetermined contacts—in this case, to a 9-1-1 operator, a private security monitoring company associated with the present invention, or other predetermined contacts. In an embodiment, pressing the panic button 24 may initiate the emergency communications as well as activating the video camera 44 to generate and transmit video data (step 106) while in other embodiments, simultaneous actuation of both the record button 22 and panic button 24 may be required in order to actuate both functions.

Actuation of the panic button 24 or another input button, may further cause electrical activation of a lighting device 26. The lighting device 26 may be positioned on an exterior surface of the top wall 18 or other wall of the housing 14 and be electrically connected to the processor 30. When a respective input button 32 is actuated, the lighting device 26 is illuminated both to enable a user to see her environment but also to draw the attention of bystanders to what may be a dangerous situation (see step 104).

In still another aspect, the personal securing system 10 may include a global position satellite (GPS) module 46 in data communication with the processor 30, the GPS 46 being operable to determine its own global position with remarkable accuracy. The GPS 46 is operably controlled by the processor 30 according to programming of the software application being executed thereby. Accordingly, the GPS 46 may be actuated to determine a present geographic position when actuated by a respective input button 32 or, in an embodiment, only when either the record button 22 or panic button 24, or both, are actuated by a user. In other words, a current geographic position of the housing 14 may be transmitted every time the transmitter 36 transmits any other data or only in specific circumstances as described above.

Further, an audible alarm 48 may be situated in the housing 14 of the alert device 12 and is electrically connected to the processor 30 and to a speaker 49. According to programming executed by the processor 30, the alarm 48 may be activated, such as when the record button 22 and panic button 24 are simultaneously actuated. The speaker 49 may be situated in the interior area of the housing 14 yet extend through a respective wall so that sounds from the speaker 49 are more clearly heard in areas remote from the housing 14. In yet another aspect, the present invention may include a microphone 33 that is operable, upon activation of a respective input button (not shown) to record a user's own voice message to be transmitted, such as to be heard by a parent, security authority, or the like.

In use, the personal securing system 10 may operate as follows (FIG. 3): the plurality of input buttons (also referred to as security buttons) are in electrical and data communication with the processor 30, the processor being situated in the electronics box within the interior area of the housing 14. Predetermined messages associated with each one of the plurality of input buttons are stored in the non-volatile memory 38 and may be transmitted by the transmitter 36 when as associated input button is pressed and according to programming executed by the processor 30. The input buttons 32 may be traditional buttons, a touch screen, or even a dial and indicia for selection of an appropriate action. The programming instructions may be provided in the form of computer software installed on and executed by the processor 30 (i.e. “the app”).

In one instance, a social occasion between two persons (referred to as “a date”) may involve driving to a restaurant or movie theater or the like. Using the present invention, a party to the date may desire to let her parents know when the parties have reached their destination. Accordingly, a single press of a signal alert indicator 20 results in transmittal of a first message indicative of feeling safe and having reached the expected location.

In another instance, a date may have progressed further and the couple may be in a vehicle parked in a so-called quiet and scenic location. The young lady may feel uncomfortable or insecure should her date begin acting more aggressively or sexually than is welcomed or reciprocated. Upon assessing the situation, the lady may choose to actuate an input button associated with needing an interruption event or even one that contacts law enforcement with a predetermined text or voice message. Again, this action may be done in a clandestine manner as no numbers need to be dialed on a cell phone, no words need to be spoken, and no lengthy text message needs to be typed—all of which may anger the other party and lead to violence and harm. The police or parent will just show up unannounced.

In yet another scenario, a person may find themselves in an immediate threat situation. For example, a young lady jogging in a park may be confronted by an attacker. The alert device, which may be worn around the neck, is operable to assist in this situation. Specifically, the user (in this case the jogger) may select and actuate the immediate-harm or panic button 24, causing an audible and visual alarm to sound through a speaker in the alert device, and transmits a message to authorities (and other predetermined contacts) indicating an assault in progress and including GPS location data. The user may also choose to operate the camera 44 to take pictures of the attacker, such pictures also being transmitted to authorities. It is understood that the alarm and transmissions may continue until the user is confirmed as being safe; in other words, the alarm is not easily terminated by the attacker.

Accordingly, the present alert device and security system according to the present invention provides a new level of security to a user such as a young woman who may find herself in uncomfortable and sometimes dangerous conditions.

1. A personal security system, comprising:
a user alert device that includes a housing having a plurality of walls that, together, define an interior area, said user alert device including:
a processor positioned in said interior area and operable to execute programming instructions;
a non-volatile memory electrically connected to said processor and configured to store data and programming, said data including a plurality of messages coded as transmittable signals;
a transmitter in data communication with said processor and operable to transmit a signal when actuated;
wherein said alert device includes a plurality of input buttons in data communication with said processor, one of said input buttons being an alert level selector;
a software application stored in said memory and executed by said processor, said software application operable to:
when said alert level selector is pressed one time, actuate said transmitter to transmit a first signal indicative of a first message stored in said memory;
when said alert level selector is pressed two times, actuate said transmitter to transmit a second signal indicative of a second message stored in said memory.

2. The personal security system as in claim 1, wherein said software application is operable, when said alert level selector is pressed three times, to actuate said transmitter to transmit a third signal indicative of a third message stored in said memory.

3. The personal security system as in claim 2, wherein said housing includes:
a front wall, a rear wall opposite said front wall, a top wall, a rear wall opposite said top wall, and a pair of side walls extending between said top wall and said bottom wall, respectively, that, together define said interior area;
wherein one of said plurality of input buttons is a record button and another of said plurality of input buttons is a panic button.

4. The personal security system as in claim 2, wherein:
said data includes a first set of contact data associated with said first signal;
said software application is operable to actuate said transmitter to transmit said first signal to said first set of contact data;
said data includes a second set of contact data associated with said second signal;
said software application is operable to actuate said transmitter to transmit said second signal to said second set of contact data.

5. The personal security system as in claim 4, wherein:
said data includes a third set of contact data associated with said third signal;
said software application is operable to actuate said transmitter to transmit said third signal to said third set of contact data.

6. The personal security system as in claim 3, further comprising:
a video camera situated in said interior area and in data communication with said processor and said transmitter, said video camera having a lens directed away from said housing;
wherein said software application is operable, when said record button is pressed, to actuate said video camera to record video data and to actuate said transmitter to transmit said recorded video data.

7. The personal security system as in claim 6, wherein said software application is operable, when said record button and said panic button are pressed simultaneously, to actuate said transmitter to actuate said video camera to record video data and to transmit said recorded video data and to transmit an accompanying emergency message to a security contact entity.

8. The personal security system as in claim 3, further comprising a plurality of light emitting diodes (LEDs) on said front wall and electrically connected to said processor and operable to illuminate in accordance with actuation of said alert level selector.

9. The personal security system as in claim 1, further comprising:
a global position satellite (GPS) module positioned in said interior area of said housing and is in data communication with said processor and operable to produce position data indicative of a geographic position of said user alert device;
wherein said software application is in data communication with said processor, and operable to cause said position data to be transmitted by said transmitter when said transmitter is energized.

10. The personal security system as in claim 7, further comprising:
an audible alarm positioned in said interior area of said housing and electrically connected to said processor;
wherein said software application is operable to energize said audible alarm when said record button and said panic button are pressed simultaneously.

11. The personal security system as in claim 10, comprising:
a speaker positioned in said interior area of said housing and electrically connected to said audible alarm and operable to emit a siren-like sound when said audible alarm is energized;
a light positioned on an exterior wall of said housing and electrically connected to said audible alarm and operable to emit a siren-like sound when said audible alarm is energized.

12. The personal security system as in claim 2, wherein:
said first message is indicative of safely arriving at a destination;
said second message is indicative of not feeling safe and asking to be picked up; and
said third message is indicative of requesting police to respond to a current location immediately.

13. The personal security system as in claim 1, wherein said transmitter is one of a wi-fi, Bluetooth, or cellular communication module.

14. The personal security system as in claim 1, wherein said plurality of contacts includes telephone numbers or email address associated with individuals and security entities associated with a user of said alert device.

15. A personal security system, comprising:
a user alert device that includes a housing having a plurality of walls that, together, define an interior area, said user alert device including:
a processor positioned in said interior area and operable to execute programming instructions associated with a software application;
a non-volatile memory electrically connected to said processor and configured to store data and said programming instructions, said data including a plurality of messages coded as transmittable signals;
wherein said plurality of messages are indicative of emotional evaluations of safety of a user and requests for help, respectively;
a transmitter in data communication with said processor and operable to transmit a signal when actuated;
wherein said alert device includes a plurality of input buttons in data communication with said processor;
wherein one of said input buttons is an alert level selector;
a software application stored in said memory and executed by said processor, said software application being operable to:
actuate said transmitter to transmit a first signal indicative of a first message stored in said memory only when said alert level selector is pressed one time;
actuate said transmitter to transmit a second signal indicative of a second message stored in said memory only when said alert level selector is pressed two times;
actuate said transmitter to transmit a third signal indicative of a third message stored in said memory only when said alert level selector is pressed three times.

16. The personal security system as in claim 15, wherein said housing includes a front wall, a rear wall opposite said front wall, a top wall, a rear wall opposite said top wall, and a pair of side walls extending between said top wall and said bottom wall, respectively, that, together define said interior area;
wherein one of said plurality of input buttons is a record button and another of said plurality of input buttons is a panic button.

17. The personal security system as in claim 15, wherein:
said data includes a first set of contact data stored in said memory and associated with said first message;
said software application is operable to actuate said transmitter to transmit said first signal to said first set of contact data;
said data includes a second set of contact data stored in said memory and associated with said second message;
said software application is operable to actuate said transmitter to transmit said second signal to said second set of contact data;
said data includes a third set of contact data stored in said memory and associated with said third message;
said software application is operable to actuate said transmitter to transmit said third signal to said third set of contact data.

18. The personal security system as in claim 16, further comprising:
a video camera situated in said interior area and in data communication with said processor and said transmitter, said video camera having a lens directed away from said housing;
wherein said software application is operable, when said record button is pressed, to actuate said video camera to record video data and to actuate said transmitter to transmit said recorded video data.

19. The personal security system as in claim 18, wherein said software application is operable, when said record button and said panic button are pressed simultaneously, to actuate said transmitter to actuate said video camera to record video data and to transmit said recorded video data and to transmit an accompanying emergency message to a security contact entity.

20. The personal security system as in claim 15, further comprising:
a global position satellite (GPS) module positioned in said interior area of said housing and is in data communication with said processor and operable to produce position data indicative of a geographic position of said user alert device;
wherein said software application is in data communication with said processor, and operable to cause said position data to be transmitted by said transmitter when said transmitter is energized.

21. The personal security system as in claim 19, further comprising:
an audible alarm positioned in said interior area of said housing and electrically connected to said processor;
wherein said software application is operable to energize said audible alarm when said record button and said panic button are pressed simultaneously.
